(19) United States
(12) Patent Application Publication
(10) Pub. No.: US 2016/0355040 A1
(43) Pub. Date: Dec. 8, 2016

(54) PLANOGRAPHIC PRINTING PLATE AND PREPARATION METHOD AND USE THEREOF

(71) Applicant: INSTITUTE OF CHEMISTRY, CHINESE ACADEMY OF SCIENCES, Beijing (CN)

(72) Inventors: Haihua Zhou, Beijing (CN); Yanlin Song, Beijing (CN)

(73) Assignee: INSTITUTE OF CHEMISTRY, CHINESE ACADEMY OF SCIENCES, Beijing (CN)

(21) Appl. No.: 14/809,515

(22) Filed: Jul. 27, 2015

(30) Foreign Application Priority Data
Jun. 2, 2015 (CN) 201510295794.3

(51) Int. Cl. B41N 1/04

(52) U.S. Cl. CPC B41N 1/04

(57) ABSTRACT

The present invention pertains to the field of printing plates and discloses a planographic printing plate and preparation method. The planographic printing plate comprises: a metal substrate, a hydrophobic priming coat formed on a surface of the metal substrate and a hydrophilic graphic layer formed on the priming coat, wherein the hydrophobic priming coat is formed by a hydrophobic primer liquid through curing, the hydrophilic graphic layer is formed by inkjet-printing and curing a printing plate-making ink on the hydrophobic priming coat. The planographic printing plate according to the present invention may be printed by using water-based ink, so it can avoid the environmental pollution caused by using solvent-based ink during planographic printing. Further, through the cooperation of the hydrophobic priming coat formed by the hydrophobic primer liquid and the hydrophilic graphic layer formed by the printing plate-making ink, printed matters with desirable image resolution can be obtained.

### CROSS REFERENCE TO RELATED APPLICATIONS

This application claims priority to Chinese Application No. 201510295794.3, filed on Jun. 2, 2015, entitled “A Planographic Printing Plate and Preparation Method and Use thereof”, which is specifically and entirely incorporated by reference.

### FIELD OF THE INVENTION

The present invention relates to a planographic printing plate and preparation method and use thereof.

### BACKGROUND OF THE INVENTION

At present, planographic printing is one of the main printing methods in China, and the printing inks used by it are mostly solvent-based inks. These inks must use toxic and harmful solvents during production. Consequently, hundreds of thousands of tons of VOCs (Volatile Organic Compounds) are directly emitted each year, causing serious pollution to the environment.

Due to requirements for environmental protection and the shortage of petroleum raw materials, water-based printing ink has achieved fast progress and development. However, water-based ink currently is mainly used in flexographic printing and intaglio printing, so it is urgent to develop a planographic printing plate that can use water-based printing ink.

### SUMMARY OF THE INVENTION

The object of the present invention is to overcome the current problem of environmental pollution caused by use of solvent-based ink during planographic printing, and to provide a novel planographic printing plate which can use water-based ink to print as well as preparation method and use thereof. If the planographic printing plate according to the present invention is adopted, printed matters with desirable image resolution can be obtained.

In order to realize the foregoing object, the first aspect of the present invention is to provide a planographic printing plate including a metal substrate, a hydrophobic priming coat formed on a surface of the metal substrate and a hydrophilic graphic layer formed on the priming coat, wherein the hydrophobic priming coat is formed by a hydrophobic primer liquid through curing, the hydrophilic graphic layer is formed by inkjet-printing and curing a printing plate-making ink onto the hydrophobic priming coat. Based on the total weight of the printing plate-making ink, the components of the printing plate-making ink and their contents are: 0.5-20 wt. % of a first film-forming resin, 0-15 wt. % of a second film-forming resin, 0.01-5 wt. % of a nanoscale or micron-scale dye, 0-5 wt. % of an additive, and a solvent, wherein, the first film-forming resin is a homopolymer of (meth)acrylic acid or a copolymer of (meth)acrylic acid and C₁₋₄ alkyl (meth)acrylate. Based on the total weight of the hydrophobic primer liquid, the components of the hydrophobic primer liquid and their contents are: 0.01-20 wt. % of a polyolefin, 0-5 wt. % of a metal adhesion promoter, and a solvent.

A second aspect of the present invention is to provide a method for preparing the foregoing planographic printing plate, including applying and curing the hydrophobic primer liquid on the surface of the metal substrate to form the hydrophobic priming coat, and inkjet printing and curing the printing plate-making ink onto the hydrophobic priming coat to form the hydrophilic graphic layer.

The planographic printing plate provided by the present invention can mitigate the current environmental pollution caused by using solvent-based ink during planographic printing because it is capable of using water-based ink to print. Further, through the cooperation of the hydrophobic priming coat formed of the hydrophobic primer liquid and the hydrophilic graphic layer formed of the printing plate-making ink, printed matters with desirable image resolution can be obtained.

Other features and advantages of the present invention will be described in details in the subsequent embodiments.

### DETAILED DESCRIPTION OF THE EMBODIMENTS

Embodiments of the present invention are described below in detail. It should be understood that the embodiments described herein are intended to illustrate and explain the present invention and not to limit the present invention.

In the present invention, (meth)acrylic acid denotes acrylic acid or methacrylic acid; likewise, C₁₋₄ alkyl (meth)acrylate denotes C₁₋₄ alkyl acrylate or C₁₋₄ alkyl methacrylate.

The planographic printing plate provided by the present invention includes a metal substrate, a hydrophobic priming coat formed on a surface of the metal substrate and a hydrophilic graphic layer formed on the priming coat, wherein the hydrophobic priming coat is formed by a hydrophobic primer liquid through curing, the hydrophilic graphic layer is formed by inkjet-printing and curing a printing plate-making ink onto the hydrophobic priming coat. Based on the total weight of the printing plate-making ink, the components of the printing plate-making ink and their contents are: 0.5-20 wt. % of a first film-forming resin, 0-15 wt. % of a second film-forming resin, 0.01-5 wt. % of a nanoscale or micron-scale dye, 0-5 wt. % of an additive, and a solvent (the solvent may be present of a rest amount), wherein, the first film-forming resin is a homopolymer of (methyl) acrylic acid or a copolymer of (meth)acrylic acid and C₁₋₄ alkyl (meth)acrylate. Based on the total weight of the hydrophobic primer liquid, the components of the hydrophobic primer liquid and their contents are: 0.01-20 wt. % of a polyolefin, 0-5 wt. % of a metal adhesion promoter, and a solvent (the solvent may constitute the remaining amount).

The metal substrate, hydrophobic priming coat and hydrophilic graphic layer of the planographic printing plate provided by the present invention are described below in detail

Metal Substrate

According to the present invention, the metal substrate may be any substrate known in the art commonly used for a planographic printing plate. For example, the metal substrate may be aluminum substrate, zinc substrate or aluminum alloy substrate, and is preferably aluminum substrate or aluminum alloy substrate.

In order to raise the adhesion of the surface of the metal substrate and the hydrophobic priming coat, preferably the surface of the metal substrate has a microstructure, which is preferably a nano-micron structure. The microstructure on the surface of the metal substrate may be formed through electrolytic graining treatment and may also be formed by applying a coating containing nano particles on the surface of the metal substrate.

Electrolytic graining treatment is a process including electrolysis and anodic oxidation treatment.

The electrolyte of the electrolysis may be an acidic aqueous solution of hydrochloric acid or phosphoric acid. Preferably, this acidic aqueous solution further contains one or more of aluminum salt, benzoic acid, salicylic acid, acetic acid, tartaric acid, dihydroxy acetic acid, malonic acid, citric acid, malic acid or aniline, ethylamine, aziridine, ethanediamine and ethanolamine. When the acidic water solution contains a foregoing substance, the concentration of the foregoing substance may be 0.1-10 g/L.

Electrolytic graining treatment may be one-time electrolysis, two-time electrolysis or three-time electrolysis. The preferred electrolytic graining treatment is three-time electrolysis. For three-time electrolysis, the following conditions are preferred: an electrolyte solution selected for first electrolysis is a hydrochloric acid water solution with hydrochloric acid concentration of 20-30 g/L, electrolysis time is 20-80 s and temperature is 20-50° C.; an electrolyte solution selected for second electrolysis is a hydrochloric acid water solution with hydrochloric acid concentration of 10-20 g/L, electrolysis time is 20-50 s and temperature is 20-50° C.; an electrolyte solution selected for third electrolysis is a hydrochloric acid water solution with hydrochloric acid concentration of 1-10 g/L, electrolysis time is 10-40 s and temperature is 20-50° C.

For the anodic oxidation treatment, an electrolyte solution for anodic oxidation is a sulfuric acid solution with sulfuric acid concentration of 150-300 g/L. In addition, a modifier is added to the electrolyte solution for anodic oxidation, with a concentration of 10-50 g/L in the electrolyte solution. The modifier may be one or more of polyethylene glycol, ethylene glycol, ethylene glycol butyl ether and dimer acid. In the process of anodic oxidation, it is preferred to allow a voltage reaching 8-30 V in 20 s and then to keep the voltage stable, with current raising continuously, until the current is stabilized at 6-100 A. Oxidation is conducted for 10-80 s at a constant current.

A coating containing nano particles may be applied on the surface of the metal substrate using spin coating or roller coating. The preferred size of the foregoing nano particles is 10-1000 nm. Further, thickness of the metal substrate may be a conventional thickness in the art, 0.1-0.5 mm for example.

Hydrophobic Priming Coat

In the present invention, the hydrophobic priming coat is formed by applying and curing the hydrophobic primer liquid on the surface of a metal substrate with or without the microstructure. Based on the total weight of the hydrophobic primer liquid, the components of the hydrophobic primer liquid and their contents are: 0.01-20 wt. % of a polyolefin, 0-5 wt. % of a metal adhesion promoter, and a solvent.

In order to increase adhesion of the metal substrate and the hydrophobic priming coat, and obtain a printed matter with more desirable image resolution, preferably the components of the hydrophobic primer liquid and their contents are: 1-15 wt. % of a polyolefin, 0-3 wt. % of a metal adhesion promoter, and a solvent. More preferably, the components of the hydrophobic primer liquid and their contents are: 2-10 wt. % of a polyolefin, 0.2-2 wt. % of a metal adhesion promoter, and a solvent. There are no special requirements for the polyolefin as long as it can be dissolved in the solvent to form the hydrophobic priming coat.

In order to further raise the image resolution of printed matters, the foregoing polyolefin preferably contains a polymer represented by Formula (1):

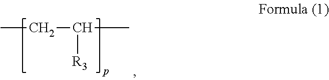

In Formula (1), R₃ is hydrogen, alkyl with 1-4 carbon atoms (such as: methyl, ethyl, propyl, isopropyl and butyl), aryl with at least one benzene ring, or halogen, and p≧5. More preferably, R₃ is hydrogen, methyl, ethyl, propyl, phenyl, bromine or chlorine. Still more preferably, R₃ is hydrogen, phenyl or chlorine. Preferably, p is 5-2000.

Examples of polyolefin in the present invention include polyethylene, polypropylene, polybutylene, polypentylene, polystyrene and polyvinyl chloride. In a preferred embodiment of the present invention, the polyolefin is one or more of polyethylene, polypropylene, polystyrene and polyvinyl chloride.

In order to increase the adhesion of the metal substrate and the hydrophobic priming coat, the hydrophobic primer liquid is preferred to contain a metal adhesion promoter. The metal adhesion promoter may be a common reagent promoting metal adhesion in the art. The metal adhesion promoter preferably is one or more of silane coupling agent, titanate coupling agent, aryl phosphate, hyperphosphate polyester polymer, alkyl phosphate, zirconium aluminate and zirconate. In the foregoing aryl phosphate type metal adhesion promoter, aryl is a substituted or non-substituted aryl, preferably phenyl, tolyl or naphthyl. The alkyl of the foregoing alkyl phosphate preferably is an alkyl with 1-20 carbon atoms. The foregoing zirconium aluminate preferably is potassium zirconium aluminate or sodium zirconium aluminate. The foregoing zirconate preferably is a meta-zirconate M²⁺ZrO₃ (M is a divalent metal), a pyro-zirconate M³⁺Zr₂O₇(M is lanthanum, cerium, neodymium or samarium), M₄³⁺Zr₃O₁₂ (M is scandium or ytterbium), Ti—ZrO₄, V₂ZrO₇, Nb₁₀ZrO₂₇, MO₂ZrO₄ or W₂ZrO₈.

In the present invention, the solvent in the hydrophobic primer liquid preferably is one or more of ethyl acetate, acetone, butanone, tetrahydrofuran, toluene, xylene, dimethylformamide, diethylformamide, dimethylacetamide, diethylacetamide, cyclohexanone, chloroform and tetrachloromethane.

According to the present invention, the hydrophobic primer liquid may be obtained by evenly mixing the foregoing raw materials. The hydrophobic primer liquid may be applied onto the surface of a metal substrate by a method of roller coating, extrusion coating or spray coating and then is cured to obtain the hydrophobic priming coat. The curing method may be a conventional method in the art, heating curing for example. Further, thickness of the hydrophobic priming coat may be a conventional thickness in the art, 0.01-10 μm for example.

Hydrophilic Graphic Layer

In the present invention, the hydrophilic graphic layer is on the hydrophobic priming coat and is formed by inkjet-printing and curing a printing plate-making ink on the hydrophobic priming coat.

Based on the total weight of the printing plate-making ink, the components of the printing plate-making ink and their contents are: 0.5-20 wt. % of a first film-forming resin, 0-15 wt. % of a second film-forming resin, 0.01-5 wt. % of a nanoscale or micron-scale dye, 0-5 wt. % of an additive, and a solvent.

In the present invention, the first film-forming resin is a necessary component of the printing plate-making ink (referred as a water-based printing ink below). It is a homopolymer of (meth)acrylic acid or a copolymer of (meth)acrylic acid and C₁₋₄ alkyl (meth)acrylate. By using the planographic printing plate prepared by using the water-based printing ink containing the first film-forming resin combined with the hydrophobic primer liquid containing the polyolefin, printed matters with desirable image resolution can be obtained.

In order to obtain printed matters with more desirable image resolution, preferably, based on the total weight of the printing plate-making ink, the components of the printing plate-making ink and their contents are: 0.5-15 wt. % of the first film-forming resin, 0.1-15 wt. % of the second film-forming resin, 0.02-2 wt. % of the nanoscale or micron-scale dye, 0-3 wt. % of the additive, and a solvent. More preferably, based on the total weight of the water-based printing ink, the components of the water-based printing ink and their contents are: 1-10 wt. % of the first film-forming resin, 1-10 wt. % of the second film-forming resin, 0.05-1 wt. % of the nanoscale or micron-scale dye, 0.01-2 wt. % of the additive, and a solvent.

In an embodiment of the present invention, based on the total weight of the hydrophobic primer liquid, the components of the hydrophobic primer liquid and their contents are: 2-10 wt. % of the polyolefin, 0.2-2 wt. % of the metal adhesion promoter, and a solvent. Based on the total weight of the water-based printing ink, the components of water-based printing ink and their contents are: 1-10 wt. % of the first film-forming resin, 1-10 wt. % of the second film-forming resin, 0.05-1 wt. % of the nanoscale or micron-scale dye, 0.01-2 wt. % of the additive, and a solvent. Through cooperation of the hydrophobic priming coat formed by the hydrophobic primer liquid with the foregoing components and contents and the hydrophilic graphic layer formed by the printing plate-making ink with the foregoing components and contents, printed matters with more desirable image resolution can be obtained.

In the present invention, the first film-forming resin is a (meth)acrylic resin. The present invention does not have special requirements for the molecular weight of this resin as long as it can be used as a film-forming resin. In order to obtain printed matters with more desirable image resolution, preferably, the number-average molecular weight of the homopolymer of (meth)acrylic acid or the copolymer of (meth)acrylic acid and C₁₋₄ alkyl (meth)acrylate is 500-100000, more preferably 1000-50000. The number-average molecular weight may be determined by gel permeation chromatography (GPC).

Further, when the first film-forming resin is a copolymer of (methyl) acrylic acid and C₁₋₄ alkyl (methyl) acrylate, there are no special requirements for the ratio of structural units as long as it can be used as a film-forming resin. In order to obtain printed matters with more desirable image resolution, preferably, the molar ratio between the structural units from (methyl) acrylic acid and the structural units from C₁₋₄ alkyl (methyl) acrylate is 1:10-10:1.

In the present invention, the C₁₋₄ alkyl (meth)acrylate preferably is methyl (meth)acrylate, ethyl (meth)acrylate, propyl (meth)acrylate or butyl (meth)acrylate, more preferably, methyl (meth)acrylate or ethyl (meth)acrylate and still more preferably methyl (meth)acrylate.

Examples of the first film-forming resin in the present invention include polyacrylic acid, poly(meth)acrylic acid, copolymer of (meth)acrylic acid and methyl (meth)acrylate, copolymer of (meth)acrylic acid and ethyl (meth)acrylate, copolymer of (meth)acrylic acid and propyl (meth)acrylate, copolymer of (meth)acrylic acid and butyl (meth)acrylate. In a preferred embodiment of the present invention, the first film-forming resin is one or more of polyacrylic acid, polymethacrylic acid, copolymer of methacrylic acid and methyl methacrylate, copolymer of methacrylic acid and methyl acrylate and copolymer of acrylic acid and methyl acrylate.

In the present invention, the second film-forming resin may be a common film-forming resin in the art. In order to obtain printed matters with more desirable image resolution, preferably, the second film-forming resin is one or more of polyethylene glycol, polyvinyl alcohol, polyoxyethylene, polyvinylpyrrolidone, urea resin, polyacrylamide, polyamine, polymaleic anhydride, water soluble epoxy resin, water soluble phenolic resin and water soluble polyurethane. More preferably, the second film-forming resin is one or more of urea resin, water soluble epoxy resin, water soluble phenolic resin, water soluble polyurethane and polyvinyl alcohol. The foregoing polyethylene glycol (PEG) preferably is one or more of PEG 400, PEG 10000, PEG 6000 or PEG 2000.

The dye may be a common dye in the art. Preferably, the dye is a dye of any color selected from acidic dye, reactive dye and basic dye with a particle size of 5-1000 nm. The foregoing acidic dye preferably is one of dye Acid Blue 9, dye Acid Blue 9 SF and dye Acid Yellow 23 SF. The foregoing reactive dye preferably is one of black dye SP series or Reactive Black. The foregoing basic dye preferably is one of Basic Brilliant Blue and Victoria blue among blue dyes.

The printing plate-making ink according to the present invention may also contain an additive commonly used in printing plate-making ink. For example, the additive may be one or more of color fixing agent, defoaming agent and antioxidant. The foregoing color fixing agent preferably is one or more of cetyl pyridinium chloride, cetyl pyridinium bromide, polyethylenimine, polyvinylamine, poly(diallyl dimethyl ammonium chloride), amine-aldehyde resin type dicyandiamide formaldehyde precondensate (color fixing agents Y and M) and reactive dye color fixing agent KS. The foregoing defoaming agent preferably is one or more of silicone emulsion, higher alcohol fatty acid ester complex, polyoxyethylene polyoxypropylene pentaerythritol ether, polyoxyethylene polyoxypropylene amine ether, polyoxypropylene glycerol ether, polyoxypropylene polyoxyethylene glycerol ether and polydimethylsiloxane. The foregoing antioxidant preferably is one or more of ascorbic acid, tea polyphenol, butylated hydroxyanisole (BHA), dibutyl hydroxytoluene (BHT), tert-butylhydroquinone and polyol ester.

In the present invention, the solvent in the printing plate-making ink preferably is water, mixed solvent of water and low alcohol, or mixed solvent of water and alcohol ether. The foregoing low alcohol preferably is one or more of methanol, absolute ethyl alcohol, 1-propanol, 2-propanol, 2-butanol and 2-methyl-2-propanol. The foregoing alcohol ether preferably is one or more of ethylene glycol monomethyl ether, ethylene glycol monoethyl ether, ethylene glycol monobutyl ether, ethylene glycol dimethyl ether, ethylene glycol diethyl ether, propylene glycol monomethyl ether, propylene glycol dimethyl ether, propylene glycol monoethyl ether, dipropylene glycol monomethyl ether, dipropylene glycol monoethyl ether and propylene glycol methyl ether acetate.

In the present invention, the printing plate-making ink is obtained by evenly mixing the raw materials with the foregoing contents. Preferably, the evenly mixed printing plate-making ink is filtered by a vacuum filtration method to ensure the diameter of particles in the ink is 220 nm or less.

The hydrophilic graphic layer may formed by inkjet-printing and curing the printing plate-making ink onto the hydrophobic priming coat. The method of the foregoing curing may be a conventional method in the art, heat curing for example. Further, the thickness of the hydrophilic graphic layer may be a conventional thickness in the art, 100-1000 nm for example.

The present invention also provides a method for preparing the foregoing planographic printing plate, wherein the method includes applying and curing the hydrophobic primer liquid on the surface of the metal substrate to form the hydrophobic priming coat and inkjet printing and curing the printing plate-making ink onto the hydrophobic priming coat to form the hydrophilic graphic layer. The methods and conditions for applying and curing the hydrophobic primer liquid on the surface of the metal substrate to form the hydrophobic priming coat and printing and curing the printing plate-making ink on the hydrophobic priming coat to form the hydrophilic graphic layer have been described above already and will not be described again here. The present invention also provides use of the foregoing planographic printing plate in planographic printing.

Below, the present invention will be described in detail by referring to embodiments, but the present invention is not limited to the following embodiments.

### Example 1

Preparation of a hydrophobic primer liquid: Based on the total weight of the hydrophobic primer liquid, 0.01 wt. % of polyethylene granules (purchased from Maoming Petrochemical Company, brand: DNDA-7144) was dissolved in the remaining wt. % of xylene at 60° C. The mixture was stirred until thoroughly dissolved and then was filtered by Buchner funnel under vacuum.

Preparation of printing plate-making ink: Based on the total weight of printing plate-making ink, 0.5 wt. % of polyacrylic acid (purchased from J.K Scientific Ltd., brand: P10680D-AA), 15 wt. % of water soluble polyurethane (purchased from Beijing Saichuang Chemical Co., Ltd.), 0.01 wt. % of dye Acid Blue 9 (purchased from Wenzhou Longda Dyestuff Chemical Co., Ltd.), 5 wt. % of amine-aldehyde resin type dicyandiamide formaldehyde precondensate (color fixing agent Y-701, purchased from Guangzhou Junwang Biotechnology Co., Ltd.) and the remaining wt. % of water were mixed to obtain a thoroughly dissolved ink. The ink was filtered by multiple stages to ensure the diameter of the particles in the ink is 220 nm or less.

Preparation of a plate: The foregoing primer liquid was applied on an aluminum substrate without a microstructure and then was cured by heating at 80° C. for 1 hour to from a hydrophobic priming coat (thickness: 10 μm). The printing plate-making ink was output in a graphic form onto the hydrophobic priming coat by an inkjet printing method and was dried at 150° C. to form a hydrophilic graphic layer (thickness: 100 nm) to obtain a planographic printing plate.

### Example 2

Preparation of a hydrophobic primer liquid: Based on the total weight of the hydrophobic primer liquid, 20 wt. % of polyvinyl chloride (purchased from Zibo Chaoyu Trade Co., Ltd., brand: QS-1000F) was dissolved in the remaining wt. % of ethyl acetate. The mixture was stirred until thoroughly dissolved and then was filtered by Buchner funnel under vacuum.

Preparation of printing plate-making ink: Based on the total weight of printing plate-making ink, 20 wt. % of polymethacrylic acid (purchased from Tianjin Genii Hengye Technologies Co., Ltd., in a form of sodium polymethacrylate, which is neutralized with hydrochloric acid to obtain polymethacrylic acid), 0.1 wt. % of water soluble phenolic resin (purchased from Wuxi Mingyang Adhesive Material Co., Ltd.), 5 wt. % of Basic Brilliant Blue (purchased from Yiwu Yufang Pigment Store), 20 wt. % of water and the remaining wt. % of ethylene glycol monomethyl ether were mixed to obtain a thoroughly dissolved ink. The ink was filtered by multiple stages to ensure the diameter of the particles in the ink is 220 nm or less.

Preparation of a plate: The foregoing primer liquid was applied evenly by roller coating onto a zinc substrate which had undergone an anodic oxidation and then was cured by heating at 70° C. for 40 minutes to form a hydrophobic priming coat (thickness: 0.01 μm). The printing plate-making ink was output in a graphic form onto the hydrophobic priming coat by an inkjet printing method and was dried at 120° C. to form a hydrophilic graphic layer (thickness: 1000 μm) to obtain a planographic printing plate.

### Example 3

Preparation of a hydrophobic primer liquid: Based on the total weight of the hydrophobic primer liquid, 10 wt. % of polystyrene (purchased from J.K Scientific Ltd., brand: P8921-S) and 0.5 wt. % of hyperphosphate polyester polymer (purchased from Fujian Xiamen Kangdilong Trade Co., Ltd., brand: SH802) were dissolved in the remaining wt. % of ethyl acetate, the mixture was stirred until thoroughly dissolved and then was filtered by Buchner funnel under vacuum.

Preparation of printing plate-making ink: based on the total weight of printing plate-making ink, 15 wt. % of copolymer of acrylic acid-methyl acrylate (purchased from Hebei Lanqing Water Treatment Technology Co., Ltd., the molar ratio of the structural units from acrylic acid and the structural units from methyl acrylate is 1:10), 5 wt. % of PEG 10000 (purchased from Sinopharm Chemical Reagent Beijing Co., Ltd.), 0.05 wt. % of Victoria blue (purchased from Yiwu Yufang Pigment Store Company), 0.1 wt. % of reactive dye color fixing agent (environment-friendly color fixing agent JW703, purchased from Guangzhou Junwang Biotechnology Co., Ltd.), 0.1 wt. % of silicone emulsion (purchased from Guangzhou Doher Chemical Co., Ltd.) and the remaining wt. % of ethylene glycol dimethyl ether were mixed to obtain a thoroughly dissolved ink. The ink was filtered by multiple stages to ensure the diameter of the particles in the ink is 220 nm or less.

Preparation of the plate: The foregoing primer liquid was applied evenly by extrusion coating onto an aluminum alloy substrate with a coating containing nano particles (the size of nano particles is 100 nm, the thickness of the coating is 0.2 μm) and then was cured by heating at 100° C. for 30 min to form a hydrophobic priming coat (thickness: 1 μm). The printing plate-making ink was output in a graphic form onto the hydrophobic priming coat by an inkjet printing method and was dried at 150° C. to form a hydrophilic graphic layer (thickness: 500 nm) to obtain a planographic printing plate.

### Example 4

Preparation of a hydrophobic primer liquid: Based on the total weight of the hydrophobic primer liquid, 5 wt. % of polystyrene (purchased from J.K Scientific Ltd., brand: P8921-S), 10 wt. % of polyvinyl chloride (purchased from Zibo Chaoyu Trade Co., Ltd., brand: QS-1000F), 0.2 wt. % of silane coupling agent (purchased from Nanjing Aocheng Chemical Co., Ltd., brand: KH-550) and the remaining wt. % of ethyl acetate was mixed by stirring to get a thoroughly dissolved mixture. The obtained mixture was filtered by Buchner funnel under vacuum.

Preparation of printing plate-making ink: Based on the total weight of the printing plate-making ink, 5 wt. % of copolymer of acrylic acid-methyl acrylate (purchased from Hebei Lanqing Water Treatment Technology Co., Ltd., the molar ratio of the structural units from acrylic acid and the structural units from methyl acrylate is 10:1), 10 wt. % of polyacrylic acid (purchased from J.K Scientific Ltd., brand: P10680D-AA), 5 wt. % of PEG 2000 (purchased from Sinopharm Chemical Reagent Beijing Co., Ltd.), 0.1 wt. % of black dye SP (purchased from Yiwu Yufang Pigment Store Company), 0.1 wt. % of poly(diallyl dimethyl ammonium chloride), 0.05 wt. % of polyoxyethylene polyoxypropylene amine ether and the remaining wt. % of ethylene glycol diethyl ether were mixed to obtain a thoroughly dissolved ink. The ink was filtered by multiple stages to ensure the diameter of the particles in the ink is 220 nm or less.

Preparation of the plate: The foregoing primer liquid was applied evenly by spin coating onto a substrate which had undergone electrolytic graining treatment and then was cured by heating at 100° C. for 30 minutes to form a hydrophobic priming coat (thickness: 2 μm). The printing plate-making ink was output in a graphic form onto the hydrophobic priming coat by an inkjet printing method and was dried at 150° C. to form a hydrophilic graphic layer (thickness: 200 nm) to obtain a planographic printing plate.

### Example 5

Preparation of a hydrophobic primer liquid: Based on the total weight of the hydrophobic primer liquid, 10 wt. % of polystyrene (purchased from J.K Scientific Ltd., brand: P8921-S) and 2 wt. % of polyethylene (purchased from Maoming Petrochemical Company, brand: DNDA-7144) were dissolved in the remaining wt. % of butanone. The mixture was stirred until thoroughly dissolved and then was filtered by Buchner funnel under vacuum.

Preparation of printing plate-making ink: Based on the total weight of printing plate-making ink, 5 wt. % of copolymer of methacrylic acid and methyl acrylate (purchased from Hebei Lanqing Water Treatment Technology Co., Ltd., the molar ratio of the structural units from methacrylic acid and the structural units from methyl acrylate is 1:5), 2 wt. % of PEG 2000 (purchased from Sinopharm Chemical Reagent Beijing Co., Ltd.), 0.1 wt. % of black dye SP (purchased from Yiwu Yufang Pigment Store Company) and the remaining wt. % of ethylene glycol methyl ether were mixed to obtain a thoroughly dissolved ink. The ink was filtered by multiple stages to ensure the diameter of the particles in the ink is 220 nm or less.

Preparation of the plate: The foregoing primer liquid was applied by extrusion coating onto a substrate with a coating containing nano particles and then was cured by heating at 100° C. for 30 minutes to form a hydrophobic priming coat (thickness: 6 μm). The printing plate-making ink was output in a graphic form onto the hydrophobic priming coat by an inkjet printing method and was dried at 150° C. to form a hydrophilic graphic layer (thickness: 300 nm) to obtain a planographic printing plate.

### Example 6

Preparation of a hydrophobic primer liquid: Based on the total weight of the hydrophobic primer liquid, 0.01 wt. % of polypropylene granules (purchased from Maoming Petrochemical Company, brand: DNDA-7144) was dissolved in the remaining wt. % of n-heptane of 25° C. The mixture was stirred until thoroughly dissolved and then was filtered by Buchner funnel under vacuum.

Preparation of printing plate-making ink: Based on the total weight of printing plate-making ink, 0.5 wt. % of polyacrylic acid (purchased from J.K Scientific Ltd., brand: P10680D-AA), 15 wt. % of water soluble polyurethane (purchased from Beijing Saichuang Chemical Co., Ltd.), 0.01 wt. % of dye Acid Blue 9 (purchased from Wenzhou Longda Dyestuff Chemical Co., Ltd.), 5 wt. % of amine-aldehyde resin type dicyandiamide formaldehyde precondensate (color fixing agent Y-701, purchased from Guangzhou Junwang Biotechnology Co., Ltd.) and the remaining wt. % of water were mixed to obtain a thoroughly dissolved ink. The ink was filtered by multiple stages to ensure the diameter of the particles in the ink is 220 nm or less.

Preparation of the plate: The foregoing primer liquid was applied on an aluminum substrate without a microstructure and then was cured by heating at 80° C. for 1 hour to from a hydrophobic priming coat (thickness: 10.00 μm). The printing plate-making ink was output in a graphic form to the hydrophobic priming coat by an inkjet printing method and was dried at 150° C. to form a hydrophilic graphic layer (thickness: 100 nm) to obtain a planographic printing plate.

### Example 7

Preparation of a hydrophobic primer liquid: Based on the total weight of the hydrophobic primer liquid, 2 wt. % of polystyrene (purchased from J.K Scientific Ltd., brand: P8921-S) and 0.2 wt. % of hyperphosphate polyester polymer (purchased from Fujian Xiamen Kangdilong Trade Co., Ltd., brand: SI-1802) was dissolved in the remaining wt. % of ethyl acetate. The mixture was stirred until thoroughly dissolved and then was filtered by Buchner funnel under vacuum.

Preparation of printing plate-making ink: Based on the total weight of printing plate-making ink, 1 wt. % of polyacrylic acid (purchased from J.K Scientific Ltd., brand: P10680D-AA), 1 wt. % of PEG 10000 (purchased from Sinopharm Chemical Reagent Beijing Co., Ltd.), 0.05 wt. % of Victoria blue (purchased from Yiwu Yufang Pigment Store Company), 0.05 wt. % of reactive dye color fixing agent (environment-friendly color fixing agent JW703, purchased from Guangzhou Junwang Biotechnology Co., Ltd.), 0.05 wt. % of silicone emulsion (purchased from Guangzhou Doher Chemical Co., Ltd.) and the remaining wt. % of ethylene glycol dimethyl ether were mixed to obtain a thoroughly dissolved ink. The ink was filtered by multiple stages to ensure the diameter of the particles in the ink is 220 nm or less.

Preparation of the plate: The foregoing primer liquid was applied evenly by extrusion coating onto an aluminum alloy substrate with a coating containing nano particles (the size of nano particles is 100 nm, the thickness of the coating is 0.2 μm) and then was cured by heating at 100° C. for 30 minutes to form a hydrophobic priming coat (thickness: 1 μm). The printing plate-making ink was output in a graphic form onto the hydrophobic priming coat by an inkjet printing method and was dried at 150° C. to form a hydrophilic graphic layer (thickness: 500 nm) to obtain a planographic printing plate.

### Example 8

Preparation of a hydrophobic primer liquid: Based on the total weight of the hydrophobic primer liquid, 10 wt. % of polystyrene (purchased from J.K Scientific Ltd., brand: P8921-S) and 2 wt. % of hyperphosphate polyester polymer (purchased from Fujian Xiamen Kangdilong Trade Co., Ltd., brand: SI-1802) were dissolved in the remaining wt. % of ethyl acetate. The mixture was stirred until thoroughly dissolved and then was filtered by Buchner funnel under vacuum.

Preparation of printing plate-making ink: Based on the total weight of printing plate-making ink, 10 wt. % of polyacrylic acid (purchased from J.K Scientific Ltd., grade: P10680D-AA), 10 wt. % of PEG 10000 (purchased from Sinopharm Chemical Reagent Beijing Co., Ltd.), 1 wt. % of Victoria blue (purchased from Yiwu Yufang Pigment Store Company), 1 wt. % of reactive dye color fixing agent (environment-friendly color fixing agent JW703, purchased from Guangzhou Junwang Biotechnology Co., Ltd.), 1 wt. % of silicone emulsion (purchased from Guangzhou Doher Chemical Co., Ltd.) and the remaining wt. % of ethylene glycol dimethyl ether were mixed to obtain a thoroughly dissolved ink. The ink was filtered by multiple stages to ensure the diameter of the particles in the ink is 220 nm or less.

Preparation of the plate: The foregoing primer liquid was applied evenly by extrusion coating onto an aluminum alloy substrate with a coating containing nano particles (the size of nano particles is 100 nm, the thickness of the coating is 0.2 μm) and then was cured by heating at 100° C. for 30 minutes to form a hydrophobic priming coat (thickness: 1 μm). The printing plate-making ink was output in a graphic form onto the hydrophobic priming coat by an inkjet printing method and was dried at 150° C. to form a hydrophilic graphic layer (thickness: 500 nm) to obtain a planographic printing plate.

### Comparative Example 1

According to the method of example 1, the difference was that 0.5 wt. % of polyacrylic acid was replaced with 0.5 wt. % of water soluble polyurethane, to obtain a planographic printing plate.

### Comparative Example 2

According to the method of example 1, the difference was that 0.01 wt. % of polyethylene granules was replaced with the same amount of phenolic resin, to obtain a planographic printing plate.

### Test Example

Each of the planographic printing plates obtained from examples 1-8 and comparative examples 1-2 performed printing by using the water-based ink for relief printing purchased from Tianjin Printing Ink Factory. Results were measured through UGRA printing-down control strips, shown in Table 1:

TABLE 1

| | Pressrun | | |
|---|---|---|---|
| | (number | Line | Dot |
| | of runs, | resolution | resolution |
| Example | sheet) | (μm) | (%) |
| 1 | 18000 | 25 | 5-90 |
| 2 | 16000 | 20 | 5-95 |
| 3 | 20000 | 30 | 10-90 |
| 4 | 15000 | 30 | 5-90 |
| 5 | 17000 | 25 | 10-90 |
| 6 | 15000 | 20 | 5-90 |
| 7 | 22000 | 15 | 5-95 |
| 8 | 21000 | 15 | 5-95 |

The above test example indicates that the planographic printing plates provided in the present invention have desirable printability and their pressrun may be 15000 sheets or more, the resolution of the graphic centerline of printing plate may reach 15 μm, and 5-95% of the dots are complete and clear. Further, the graphic zone and the non-graphic zone cannot be clearly differentiated in the comparative examples 1 and 2 using water-based ink for printing.

The described and illustrated embodiments are to be considered as illustrative and not restrictive in character and that all changes and modifications that come within the scope of the invention, as set out in the accompanying claims, are desired to be protected. It should be understood that while the use of words such as “preferable”, “preferably”, “preferred” or “more preferred” in the description suggest that a feature so described may be desirable, it may nevertheless not be necessary and embodiments lacking such a feature may be contemplated as within the scope of the invention as defined in the appended claims. In relation to the claims, it is intended that when words such as “a,” “an,” “at least one,” or “one” are used to preface a feature there is no intention to limit the claim to only one such feature unless specifically stated to the contrary in the claim.

Above, preferred embodiments of the present invention are described in detail, but the present invention is not limited to the concrete details of the foregoing embodiments. Within the scope of the technical conception of the present invention, various simple changes may be made to the technical solutions of the present invention and are all within the scope of protection of the present invention.

Further, the technical features described in the foregoing embodiments may be combined in any appropriate way. In order to avoid unnecessary repetition, the possible combinations of the present invention are not described one by one.

1. A planographic printing plate consisting of:
a metal substrate; and
a hydrophobic priming coat formed on a surface of the metal substrate and a hydrophilic graphic layer formed on the priming coat, wherein the hydrophobic priming coat is formed by a hydrophobic primer liquid through curing, the hydrophilic graphic layer is formed by inkjet-printing and curing a printing plate-making ink onto the hydrophobic priming coat, wherein:
based on a total weight of the printing plate-making ink, the components of the printing plate-making ink and their contents are:
0.5-20 wt. % of a first film-forming resin,
0.1-15 wt. % of a second film-forming resin,
0.01-5 wt. % of a nanoscale or micron-scale dye,
0-5 wt. % of an additive, and
a solvent,
wherein, the first film-forming resin is selected from the group consisting of a homopolymer of (meth)acrylic acid and a copolymer of (meth)acrylic acid with C₁₋₄ alkyl (meth)acrylate; the second film-forming resin is selected from the group consisting of polyethylene glycol, polyvinyl alcohol, polyoxyethylene, polyvinylpyrrolidone, urea resin, polyacrylamide, polyamine, polymaleic anhydride, water soluble epoxy resin, water soluble phenolic resin water soluble polyurethane, and combinations thereof; and
based on a total weight of the hydrophobic primer liquid, the components of the hydrophobic primer liquid and their contents are:
0.01-20 wt. % of a polyolefin,
0.2-2 wt. % of a metal adhesion promoter, and
a solvent;
the polyolefin contains a polymer represented by the following formula 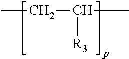
wherein R₃ is selected from the group consisting of hydrogen, phenyl, chlorine, alkyl with 1-4 carbon atoms, aryl with at least one benzene ring, bromine or chlorine, p is at least 5;
the metal adhesion promoter is selected from the group consisting of silane coupling agent, titanate coupling agent, aryl phosphate, hyperphosphate polyester polymer, alkyl phosphate, zirconium aluminate, zirconate, and combinations thereof.

2. The planographic printing plate according to claim 1, wherein the first film-forming resin is selected from the group consisting of polyacrylic acid, polymethacrylic acid, copolymer of methacrylic acid or methyl methacrylate, copolymer of methacrylic acid and methyl acrylate, copolymer of acrylic acid and methyl acrylate, and combinations thereof.

3. The planographic printing plate according to claim 1, wherein the second film-forming resin is selected from the group consisting of urea resin, water soluble epoxy resin, water soluble phenolic resin, water soluble polyurethane and polyvinyl alcohol, and combinations thereof.

4. The planographic printing plate according to claim 1, wherein the dye is a dye of any color selected from the group consisting of acidic dye, reactive dye, and basic dye, with a particle size of 5-1000 nm.

5. The planographic printing plate according to claim 1, wherein the additive is selected from the group consisting of color fixing agent, defoaming agent, antioxidant and combinations thereof.

6. The planographic printing plate according to claim 5, wherein the color fixing agent is selected from the group consisting of cetyl pyridinium chloride, cetyl pyridinium bromide, polyethylenimine, polyvinylamine, poly(diallyl dimethyl ammonium chloride), amine-aldehyde resin type dicyandiamide formaldehyde precondensate, reactive dye color fixing agent KS, and combinations thereof.

7. The planographic printing plate according to claim 5, wherein the defoaming agent is selected from the group consisting of silicone emulsion, higher alcohol fatty acid ester complex, polyoxyethylene polyoxypropylene pentaerythritol ether, polyoxyethylene polyoxypropylene amine ether, polyoxypropylene glycerol ether, polyoxypropylene polyoxyethylene glycerol ether, polydimethylsiloxane, and combinations thereof.

8. The planographic printing plate according to claim 5, wherein the antioxidant is selected from the group consisting of ascorbic acid, tea polyphenol, butylated hydroxyanisole, dibutyl hydroxytoluene, tert-butylhydroquinone, polyol ester, and combinations thereof.

9. The planographic printing plate according to claim 1, wherein the solvent in the printing plate-making ink is selected from the group consisting of water, mixed solvent of water and low alcohol, and mixed solvent of water and alcohol ether.

10. The planographic printing plate according to claim 9, wherein the low alcohol is selected from the group consisting of methanol, absolute ethyl alcohol, 1-propanol, 2-propanol, 2-butanol, 2-methyl-2-propanol, and combinations thereof.

11. The planographic printing plate according to claim 9, wherein the alcohol ether is selected from the group consisting of ethylene glycol monomethyl ether, ethylene glycol monoethyl ether, ethylene glycol monobutyl ether, ethylene glycol dimethyl ether, ethylene glycol diethyl ether, propylene glycol monomethyl ether, propylene glycol dimethyl ether, propylene glycol monoethyl ether, dipropylene glycol monomethyl ether, dipropylene glycol monoethyl ether, propylene glycol methyl ether acetate, and combinations thereof.

12. The planographic printing plate according to claim 1, wherein the surface of the metal substrate has a nano scale or micron scale structure.

13. The planographic printing plate according to claim 12, wherein the nano scale or micron scale structure is formed by a process selected from the group consisting of electrolytic graining treatment and applying a coating containing nano particles on the surface of the metal substrate.

14. The planographic printing plate according to claim 1, wherein the polyolefin in the hydrophobic primer liquid is one or more of polyethylene, polypropylene, polystyrene and polyvinyl chloride.

15. (canceled)

16. The planographic printing plate according to claim 1, wherein the solvent in the hydrophobic primer liquid is selected from the group consisting of ethyl acetate, acetone, butanone, tetrahydrofuran, toluene, xylene, dimethylformamide, diethylformamide, dimethylacetamide, diethylacetamide, cyclohexanone, chloroform, tetrachloromethane and combinations thereof.

17. The planographic printing plate according to claim 1, wherein the metal substrate is selected from the group consisting of aluminum substrate, zinc substrate, and aluminum alloy substrate.

18. A method for preparing the planographic printing plate according to claim 1 comprising:
1) applying and curing the hydrophobic primer liquid on a surface of a metal substrate to form the hydrophobic priming coat;
2) inkjet printing and curing the printing plate-making ink onto the hydrophobic priming coat to form the hydrophilic graphic layer.
